(19) United States
(12) Patent Application Publication
(10) Pub. No.: US 2026/0368798 A1
(43) Pub. Date: Nov. 19, 2026

(54) INFORMATION PROCESSING APPARATUS, METHOD, AND PROGRAM

(71) Applicant: FUJIFILM Corporation, Tokyo (JP)

(72) Inventor: Masahiro SATO, Tokyo (JP)

(73) Assignee: FUJIFILM Corporation, Tokyo (JP)

(21) Appl. No.: 19/667,686

(22) Filed: May 5, 2026

(30) Foreign Application Priority Data
May 15, 2025 (JP) 2025-082196

(51) Int. Cl. G06Q 30/0601

(52) U.S. Cl. CPC G06Q 30/0631

(57) ABSTRACT

An information processing apparatus includes a memory that stores a prediction model for predicting an item to be recommended to a user from a plurality of candidate items, and a processor. The processor derives a missing probability of a negative example among the plurality of candidate items, weights the candidate item that is the negative example based on the missing probability, and trains the prediction model by using the weighted candidate item.

### CROSS REFERENCE TO RELATED APPLICATIONS

The present application claims priority from Japanese Patent Application No. 2025-082196, filed on May 15, 2025, the entire disclosure of which is incorporated herein by reference.

### BACKGROUND

### Technical Field

The present disclosure relates to an information processing apparatus, an information processing method, and an information processing program.

### Related Art

A recommendation system that recommends an item such as a product to a user has been proposed. In such a recommendation system, a prediction model for predicting a product that a user is likely to prefer is trained according to an algorithm in which the user prefers a product similar to a product purchased by the user and does not prefer a product similar to a product not purchased by the user. For example, in JP2019-003587A, a method is proposed in which an item purchased by a user is specified, a purchasable item group excluding an item that the user could not purchase in a case where the user purchased the item is specified, and a preference of the user is learned based on the item and the purchasable item group. By using the prediction model constructed by such learning, it is possible to predict an item that the same or similar user is likely to purchase and recommend the item to the user.

However, in a case where a part of the purchasable item group is missing, the accuracy of the prediction model is decreased in a case where the learning is performed based on the purchasable item group. In general, among the purchasable item group, an item purchased by the user is used as a positive example, and an item not purchased by the user is used as a negative example for the learning. However, since the purchased item is generally recorded, the missing data is likely to occur particularly in the negative example.

### SUMMARY OF THE INVENTION

The present disclosure has been made in view of the above circumstances, and an object of the present disclosure is to enable recommendation of an item that matches a preference of a user from a plurality of candidate items.

A first information processing apparatus according to the aspect of the present disclosure comprises:
a memory that stores a prediction model for predicting an item to be recommended to a user from a plurality of candidate items; and
a processor,
in which the processor is configured to:
   derive a missing probability of a negative example among the plurality of candidate items;
   weight the candidate item that is the negative example based on the missing probability; and
   train the prediction model by using the weighted candidate item.

In the first information processing apparatus according to the aspect of the present disclosure, the processor may be configured to:
group the plurality of candidate items; and
derive the missing probability for each group.

In the first information processing apparatus according to the aspect of the present disclosure, the processor may be configured to group the plurality of candidate items based on a feature amount of each of the plurality of candidate items.

In the first information processing apparatus according to the aspect of the present disclosure, the processor may be configured to:
derive a predicted value of the candidate item for each of a plurality of users by using the prediction model;
derive a sum of the predicted values for the user for each of the plurality of candidate items; and
group the plurality of candidate items based on a magnitude of the sum.

In the first information processing apparatus according to the aspect of the present disclosure, the processor may be configured to:
derive a predicted value of the candidate item at a plurality of points in time for a single user or each of a plurality of users by using the prediction model;
derive a sum of the predicted values for the user for each of the plurality of candidate items; and
group the plurality of candidate items based on a magnitude of the sum.

In the first information processing apparatus according to the aspect of the present disclosure, the processor may be configured to:
weight the candidate item that is the negative example based on the missing probability derived for each group;
update the prediction model by using the weighted candidate item; and
repeat the derivation of the predicted value, the derivation of the sum of the predicted values, the grouping, the weighting of the candidate item, and the update of the prediction model by using the updated prediction model until a predetermined condition is satisfied.

In the first information processing apparatus according to the aspect of the present disclosure, the processor may be configured to increase the weight as the missing probability increases.

In the first information processing apparatus according to the aspect of the present disclosure, the processor may be configured to increase the number of candidate items that are the negative examples as the missing probability increases.

A second information processing apparatus according to the aspect of the present disclosure comprises:
a memory that stores a prediction model for predicting an item to be recommended to a user from a plurality of candidate items; and
a processor,
in which the processor is configured to:
   derive a missing probability of a negative example among the plurality of candidate items; and
   correct a prediction result of the prediction model based on the missing probability.

In the second information processing apparatus according to the aspect of the present disclosure, the processor may be configured to:
derive a rank corresponding to a predicted value of the item to be recommended to the user among the plurality of candidate items by using the prediction model; and
correct the prediction result of the prediction model by correcting the rank with a weight corresponding to the missing probability.

A first information processing method according to the aspect of the present disclosure is an information processing method for predicting an item to be recommended to a user from a plurality of candidate items, the method comprising:
via a computer,
deriving a missing probability of a negative example among the plurality of candidate items;
weighting the candidate item that is the negative example based on the missing probability; and
training a prediction model for predicting the item by using the weighted candidate item.

A second information processing method according to the aspect of the present disclosure is an information processing method for predicting an item to be recommended to a user from a plurality of candidate items, the method comprising:
via a computer,
deriving a missing probability of a negative example among the plurality of candidate items; and
correcting a prediction result of a prediction model for predicting the item based on the missing probability.

A first information processing program according to the aspect of the present disclosure is an information processing program causing a computer to execute a process of predicting an item to be recommended to a user from a plurality of candidate items, the process comprising:
a procedure of deriving a missing probability of a negative example among the plurality of candidate items;
a procedure of weighting the candidate item that is the negative example based on the missing probability; and
a procedure of training a prediction model for predicting the item by using the weighted candidate item.

A second information processing program according to the aspect of the present disclosure is an information processing program causing a computer to execute a process of predicting an item to be recommended to a user from a plurality of candidate items, the process comprising:
a procedure of deriving a missing probability of a negative example among the plurality of candidate items; and
a procedure of correcting a prediction result of a prediction model for predicting the item based on the missing probability.

It should be noted that the technology of the present disclosure may be applied to a program product.

According to the present disclosure, it is possible to recommend an item that matches a preference of a user from a plurality of candidate items.

### BRIEF DESCRIPTION OF THE DRAWINGS

FIG. 1 is a conceptual diagram of a recommendation system.

FIG. 2 is a conceptual diagram showing an example of supervised machine learning that is widely used for constructing a prediction model.

FIG. 3 is a diagram for describing an item that is a negative example.

FIG. 4 is a diagram for describing a rank of an item predicted by a prediction model.

FIG. 5 is a diagram showing a hardware configuration of an information processing apparatus according to the present embodiment.

FIG. 6 is a functional configuration diagram of the information processing apparatus according to the present embodiment.

FIG. 7 is a diagram for describing a weight for an item that is a negative example for a certain user.

FIG. 8 is a flowchart showing processing performed in the present embodiment.

FIG. 9 is a functional configuration diagram of an information processing apparatus according to another embodiment.

FIG. 10 is a diagram for describing correction of a rank.

FIG. 11 is a flowchart showing processing performed in another embodiment.

FIG. 12 is a flowchart of processing of machine learning of an estimation model that estimates a negative example missing probability.

FIG. 13 is a diagram showing a history of file viewing of a user on a certain day.

FIG. 14 is a diagram showing the number of views for each candidate item for the history shown in FIG. 13.

### DETAILED DESCRIPTION

Hereinafter, embodiments of the present disclosure will be described with reference to the drawings. First, an information recommendation technique will be described. The information recommendation technique is a technique for recommending an item to a user.

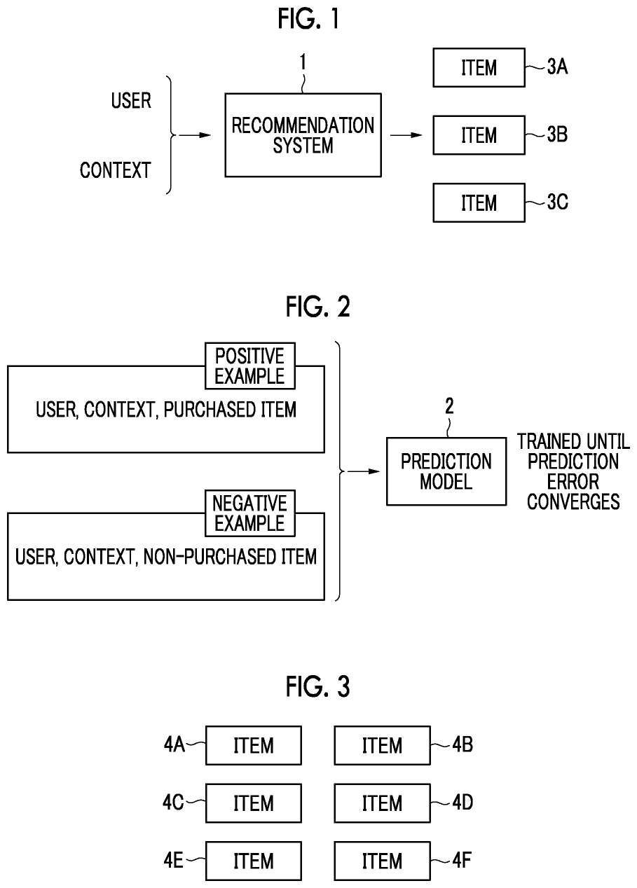

FIG. 1 is a conceptual diagram of a recommendation system. A recommendation system 1 receives information of a user and information of a context as inputs, and outputs information of an item to be recommended to the user according to the context. The context means various “situations” and may be, for example, a day of the week, a time slot, or weather. The item may be, for example, various targets such as a book, a motion picture, and a restaurant. It should be noted that the input to the recommendation system does not need to be both the information of the user and the information of the context, and may be only the information of the user or only the information of the context.

The recommendation system 1 generally recommends a plurality of items at the same time. FIG. 1 shows an example in which the recommendation system 1 recommends three items 3A to 3C. In a case where the user has a positive reaction to the recommended items 3A to 3C, the recommendation is generally considered to be successful. The positive reaction is, for example, purchase, viewing, or visit.

Such a recommendation technique is widely used, for example, in an electronic commerce (EC) site, a review site that introduces a restaurant, a movie, a product, a home appliance, and the like. In addition, the recommendation technique is also used in a medical site that provides medical data such as an image and an interpretation report to a medical worker such as a doctor in a medical field. The product in the EC site, the restaurant, the movie, the product, and the home appliance in the review site, and the medical data in the medical site are examples of the item. Hereinafter, these are collectively referred to as simply an item.

In the recommendation system 1, a prediction model that predicts an item to be recommended to the user from a plurality of candidate items that can be recommended to the user is used. The prediction model is constructed by using a machine learning technique. FIG. 2 is a conceptual diagram showing an example of supervised machine learning that is widely used in the construction of the prediction model. In general, a positive example and a negative example are prepared based on a past behavior history of the user, a combination of the user and the context is input to a prediction model 2, and the prediction model 2 is trained such that a prediction error is reduced. For example, in the EC site, among the candidate items, a purchased item purchased by the user is set as a positive example, and a non-purchased item not purchased by the user is set as a negative example. The training is performed until the prediction error converges, and target prediction performance is acquired in the prediction model 2. As a result, the prediction model 2 predicts the item to be recommended to the user from the plurality of candidate items. The convergence of the prediction error is an example of satisfying a predetermined condition in the present disclosure.

In a case where the recommendation system 1 is used in the EC site, the prediction model 2 is a model that predicts a product to be purchased by the user. In this case, the positive example is the product purchased by the user, and the negative example is the product not purchased by the user. In a case of the review site, the prediction model 2 is a review prediction model, the positive example is a restaurant or the like that is reviewed by the user, and the negative example is a restaurant or the like that is not reviewed by the user. In a case of a system in which a medical worker views medical data, the prediction model is a viewing prediction model, the positive example is medical data viewed by the user (that is, the medical worker), and the negative example is medical data not viewed by the user.

Examples of the behavior of the user for determining the positive example and the negative example for constructing the prediction model 2 include purchase, review, and viewing. However, in the present embodiment, the prediction model 2 is used as a purchase prediction model, and purchase is used as the behavior of the user for determining the positive example and the negative example.

The recommendation system 1 uses the trained prediction model 2 constructed in this way to derive, for a combination of the user and the context, a predicted value representing a probability that the user is likely to purchase, review, or view the item for all candidate items, and recommends the item having the high predicted value to the user. For example, in a case where a combination of a certain user and a certain context is input to the trained prediction model 2, the prediction model 2 outputs a predicted value representing a probability that the user is likely to purchase the item for all candidate items under the condition of the context. The recommendation system 1 recommends the item having the high predicted value to the user.

Here, the item purchased by a certain user is recorded, but the item not purchased is not recorded. Therefore, in the recommendation system 1, an item that is not purchased by a certain user (referred to as a user A) but is purchased by another user (referred to as a user B) is used as the negative example. For example, as shown in FIG. 3, it is assumed that there are six items 4A to 4F, the user A purchases the items 4A and 4B, and the user B purchases the items 4C to 4F. In this case, in a case where the prediction model 2 is trained for the user A, the items 4A and 4B are used as the positive examples, and the items 4C to 4F are used as the negative examples.

However, in a case where the user B purchases the items 4C and 4D and no user purchases the items 4E and 4F, only the items 4C and 4D are used as the negative examples for the user A. In this case, the items 4E and 4F should be used as the negative examples for the user A, but are omitted from the negative examples for the user A. The negative example that is omitted from the negative example that should be used as the negative example is referred to as a missing negative example.

For example, as described above, it is assumed that there are six items 4A to 4F shown in FIG. 3, the user A purchases the items 4A and 4B, and the user B purchases the items 4C and 4D. In this case, the items 4A and 4B are used as the positive examples for the user A, the items 4C and 4D are used as the negative examples, and the items 4E and 4F are used as the missing negative examples.

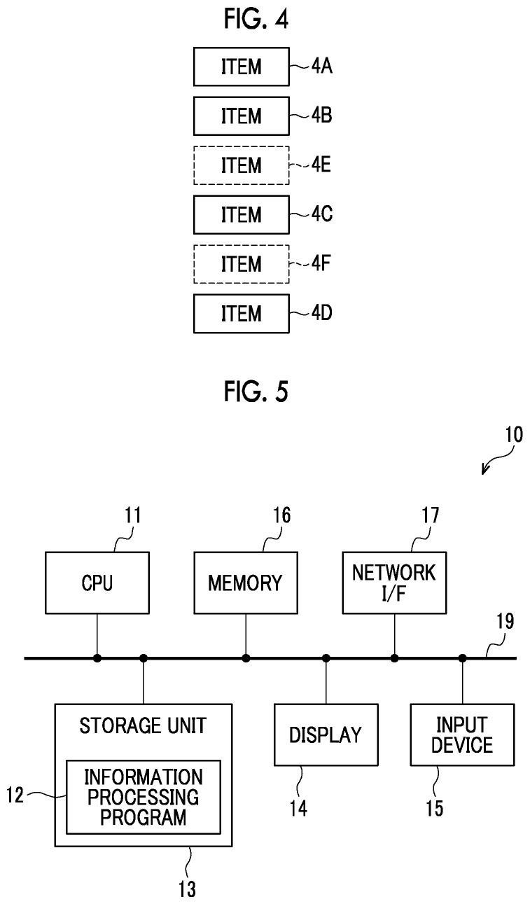

In a case where the negative example is not missing, the prediction model 2 predicts the items that the user A is likely to purchase, for example, in an order of the items 4A, 4B, 4E, 4C, 4F, and 4D as shown in FIG. 4. The order of the items 4A, 4B, 4E, 4C, 4F, and 4D is descending order of the predicted values output by the prediction model 2. However, in a case where the items 4E and 4F are missing, the predicted value of the item 4C is third, the predicted value of the item 4D is fourth, and the rank based on the predicted value is increased. Here, in a case where the system is constructed to recommend the top three items of the prediction result to the user as the correct answer, the item 4C that is not originally recommended is recommended to the user. In a case where the negative example is missing as described above, the accuracy of the prediction model 2 is decreased in a case of predicting for the user A.

In the EC site, the type of the item is changed by adding a new product, stopping the sale of an old product, or the like, and thus, it is necessary to estimate the candidate item at a point in time when each new product is added or the old product is stopped from being sold, and there is a candidate item that is not purchased by any user, so that the negative example is missing. In the review site, the site does not cover all the items, and for example, in a case of a restaurant, the item is changed due to closing, opening a new restaurant, or the like, and thus, it is necessary to estimate the candidate item at a date and time when the restaurant is closed or opened, and there is a restaurant that is not reviewed by any user, so that the negative example is missing. In the medical site, the candidate item can be understood for a specific storage location in which the medical data is stored, and all the negative examples of non-view that are not viewed by the user can be understood, but in a case where there is another storage location, the negative example that is not viewed by the user, that is, the non-view cannot be directly understood for the medical data stored in the other storage location, so that the candidate item is estimated from the viewing log of all the users, and the negative example is missing.

The present embodiment considers such a missing negative example and enables the recommendation of an item that matches the preference of the user.

FIG. 5 is a diagram showing a hardware configuration of the information processing apparatus according to the present embodiment. An information processing apparatus 10 according to the present embodiment is a computer in which the information processing program according to the present embodiment is installed, and is applied to the recommendation system 1. As shown in FIG. 5, the information processing apparatus 10 includes a central processing unit (CPU) 11, a memory 16 as a temporary storage area, and a non-volatile storage unit 13. In addition, the information processing apparatus 10 includes a display 14 such as a liquid crystal display or an organic electro-luminescence (EL) display, and an input device 15 such as a keyboard. The display 14 and the input device 15 may be integrated as a touch panel display. In addition, the information processing apparatus 10 includes a network interface (I/F) 17 connected to a network. The CPU 11, the memory 16, the storage unit 13, and the network I/F 17 are connected to a bus 19.

The storage unit 13 is implemented by a hard disk drive (HDD), a solid state drive (SSD), a flash memory, or the like. An information processing program 12 is stored in the storage unit 13 as a storage medium. The CPU 11 reads out the information processing program 12 from the storage unit 13, develops the information processing program 12 into the memory 16, and executes the developed information processing program 12.

The information processing program 12 is stored in a storage device of the server computer connected to the network or in a network storage in a state of being accessible from the outside, and is downloaded and installed on the information processing apparatus 10 in response to a request.

In addition, the storage unit 13 stores information related to results of a plurality of users using the EC site by using a communication device such as a personal computer or a smartphone of each user. Specifically, the storage unit 13 stores a purchase history (for example, a user ID of a user who has purchased a product, a purchase date and time, a name of the purchased product, and attributes of the product such as a price and a use) which is a history in which each user has purchased a product in the EC site.

The purchase histories may be collected in the information processing apparatus 10 from a web server device that manages the EC site via the Internet, or the information processing apparatus 10 itself may be the web server device that manages the EC site.

In addition, in the present embodiment, the storage unit 13 stores a prediction model 2 that predicts an item to be recommended to the user from a plurality of candidate items handled in the EC site. The prediction model 2 is constructed by performing training using a positive example and a negative example for each user and a context according to the method described with reference to FIG. 2 described above. It is assumed that the training considering the negative example missing probability according to the present embodiment is not performed in an initial state.

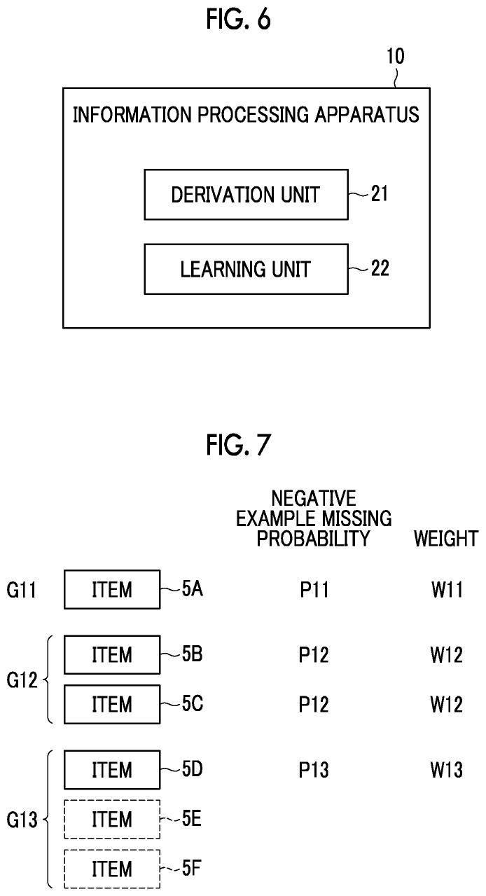

Next, a functional configuration of the information processing apparatus according to the present embodiment will be described. FIG. 6 is a diagram showing the functional configuration of the information processing apparatus according to the present embodiment. As shown in FIG. 6, the information processing apparatus 10 comprises a derivation unit 21 and a learning unit 22. Then, the CPU 11 executes the information processing program 12, thereby the CPU 11 functions as the derivation unit 21 and the learning unit 22.

The derivation unit 21 derives the missing probability of the negative example. In the present embodiment, the plurality of candidate items are grouped for each item having the same or similar attribute, and the negative example missing probability is derived for each group. Hereinafter, the grouping will be described.

The derivation unit 21 derives the predicted value of the candidate item for each user by using the prediction model 2 stored in the storage unit 13. The predicted value is a probability that each user is likely to purchase the candidate item. In a case where the item is a product, the purchase rate, which is a probability that each user is likely to purchase the product, is the predicted value. The derivation unit 21 derives the sum of the predicted values for the user for each of the plurality of candidate items. Then, the derivation unit 21 groups the plurality of candidate items based on the magnitude of the sum. For example, the plurality of candidate items are divided into three groups by dividing the magnitude of the sum into three parts.

The derivation unit 21 derives the negative example missing probability for each group. Therefore, the derivation unit 21 derives an average value ng of the number of users who have purchased the item for each group. For example, in a case where the plurality of candidate items are grouped into two groups G1 and G2, three items A11, A12, and A13 are present in the group G1, and the number of users who have purchased the items A11, A12, and A13 is two, one, and two, respectively, the average value ng of the number of users who have purchased the items is 5/3=1.67. In addition, in a case where three items A21, A22, and A23 are present in the group G2, and the number of users who have purchased the items A21, A22, and A23 is six, eight, and five, respectively, the average value ng of the number of users who have purchased the items is 19/3=6.33.

The number of purchasing users follows a Poisson distribution, but the item for which the number of purchasing users is zero is not used for deriving the average value ng. Therefore, the distribution of the number of purchasing users is a zero-truncated Poisson distribution excluding a case where the value of the random variable is zero from the Poisson distribution.

The parameter λ of the Poisson distribution can be estimated by Equation (1) using a moment method or the like.

λ/(1−e\hat{ }(−λ))=ng (1)

In a case where the parameter λ is known, the negative example missing probability of each group can be calculated by Equation (2) from the Poisson distribution. In Equation (2), X is the number of observations in the Poisson distribution, and P(X=0) is a probability in a case where the number of observations, that is, the number of purchasing users is zero. Here, in a case where the number of purchasing users is zero, since the item cannot be extracted as the candidate item, the negative example missing occurs. Therefore, P(X=0) is the negative example missing probability.

P(X=0)=e\hat{ }(−λ) (2)

The learning unit 22 weights the item that is the negative example with a larger weight as the negative example missing probability of the group to which the item is classified increases. Then, the learning unit 22 updates the prediction model 2 by retraining the prediction model 2 using the weighted item. As shown in FIG. 2, the prediction model 2 is trained by preparing the positive example and negative example items according to the behavior history of the user, inputting the positive example and negative example items, and the combination of the user and the context to the prediction model 2, and training the prediction model 2 such that the prediction error is reduced. In this case, the learning unit 22 weights the negative example item based on the negative example missing probability. The weight W for weighting is derived by Equation (3) for each group.

W=1/(1−P(X=0)) (3)

In Equation (3), the weight W increases as the negative example missing probability P(X=0) increases. FIG. 7 is a diagram for describing the weight for the item that is the negative example for a certain user. As shown in FIG. 7, it is assumed that there are six items 5A to 5F, the item 5A is grouped into a group G11, the items 5B and 5C are grouped into a group G12, and the items 5D to 5F are grouped into a group G13. It is assumed that, among the items 5A to 5F, the items 5E and 5F are the items that are not purchased by a certain user (referred to as a user A) but are purchased by a user (referred to as a user B) other than the user A. In this case, the negative example used for training the prediction model 2 for the user A is only the items 5A to 5D, and the items 5E and 5F are missing in the negative example.

In addition, it is assumed that the negative example missing probabilities derived for each of the groups G11, G12, and G13 are P11, P12, and P13, and the magnitudes thereof are P11<P12<P13. In this case, the magnitudes of the weights W11, W12, and W13 for the items of the groups G11, G12, and G13 are W11<W12<W13.

As a result, the weight of the item 5D, which is the negative example of the group G13, is increased, and the prediction model 2 is trained. As described above, even in a case where the negative example is missing in the item in the group, the weight W is increased by the amount of the missing item, so that the prediction model 2 can be trained by supplementing the missing negative example.

In a case where the negative example missing probability is extremely large, 1−P(X=0) is an extremely small value, and thus W is an extremely large value. In particular, in a case where the amount of the training data is small, the presence of the group having a large W leads to destabilization of training (increase in the variance of the objective function). Therefore, as shown in Equation (5), clipping in which an upper limit is set for the value of W may be applied.

W′=Minimum (w, C) (5)

Here, c is an upper limit value of the set W, and is, for example, 100 or the like. In this case, W′ shown in Equation (5) is used as the weight.

The learning unit 22 may change the number of samples of the item that is the negative example according to the magnitude of the negative example missing probability, that is, the magnitude of the weight W. For example, in a case where the weight W is large, the number of samples may be increased (oversampling), and in a case where the weight W is small, the number of samples may be decreased (downsampling). Specifically, an average value of the weights W for all the groups may be derived, and in a case where the weight W is twice the average value, the number of samples may be doubled, and in a case where the weight W is ½ of the average value, the number of samples may be halved.

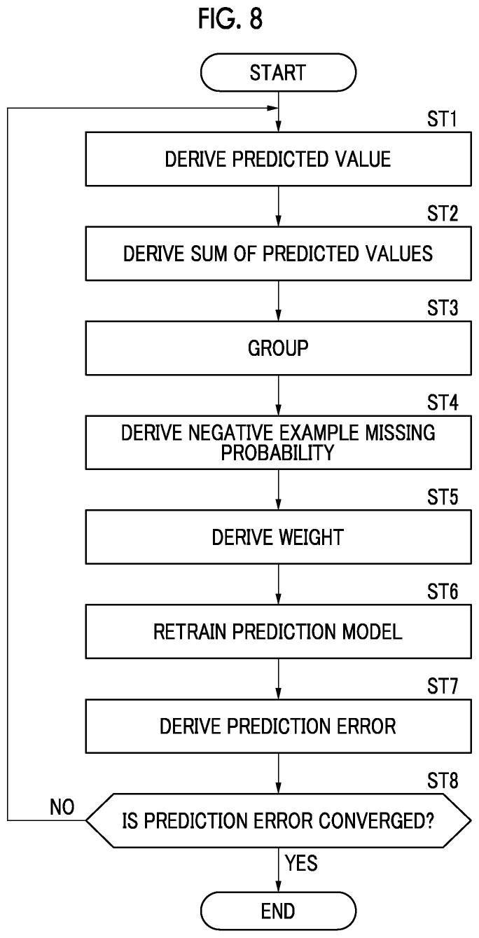

Then, processing performed in the present embodiment will be described. FIG. 8 is a flowchart showing the processing performed in the present embodiment. First, the derivation unit 21 derives the predicted value of the candidate item for each user by the prediction model 2 (step ST1). The derivation unit 21 derives the sum of the predicted values for the user for each of the plurality of candidate items (step ST2). Then, the derivation unit 21 groups the plurality of candidate items based on the magnitude of the sum (step ST3). The derivation unit 21 derives the negative example missing probability for each group (step ST4).

The learning unit 22 derives the weight W that increases as the negative example missing probability increases (step ST5), and retrains the prediction model 2 by weighting the item that is the negative example with the derived weight W (step ST6). The learning unit 22 derives the prediction error by the retrained prediction model 2 (step ST7), and determines whether or not the prediction error has converged (step ST8). In a case where a negative determination is made in step ST8, the processing returns to step ST1, and the processing of steps ST1 to ST7 is repeated. In a case where an affirmative determination is made in step ST8, the processing ends.

As described above, in the present embodiment, the negative example missing probability of the plurality of candidate items is derived for each user, the item that is the negative example is weighted based on the missing probability, and the prediction model 2 is trained by using the weighted item. Therefore, even in a case where the item that is the negative example among the plurality of candidate items is missing, the prediction model 2 can be trained by compensating for the missing item. Therefore, by using the trained prediction model 2, it is possible to recommend the item that matches the preference of the user from the plurality of candidate items to the user.

In the above-described embodiment, the prediction model is trained until the prediction error converges, but the present disclosure is not limited thereto. The prediction model may be trained until the training is performed a predetermined number of times. In this case, the training performed a predetermined number of times is an example of satisfying the predetermined condition in the present disclosure.

In addition, in the above-described embodiment, the prediction model 2 is retrained by using the negative example missing probability, but the present disclosure is not limited thereto. The prediction result of the prediction model 2 may be corrected. In the following, this case will be described as another embodiment. Since a hardware configuration of the information processing apparatus according to another embodiment is the same as that of the above-described embodiment, a detailed description of the hardware configuration will be omitted here.

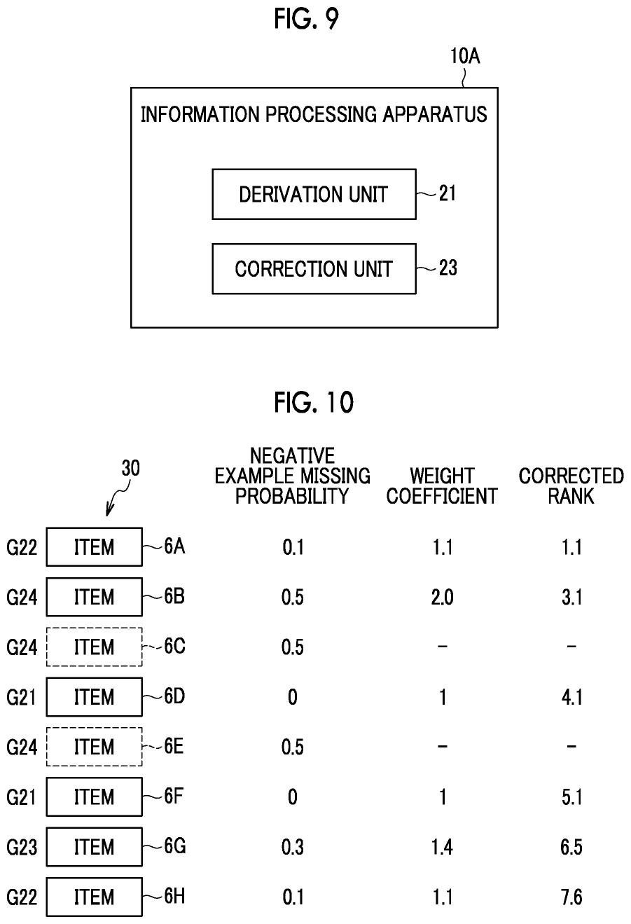

FIG. 9 is a diagram showing a functional configuration of the information processing apparatus according to another embodiment. As shown in FIG. 9, an information processing apparatus 10A according to another embodiment comprises a derivation unit 21 and a correction unit 23.

The derivation unit 21 performs the grouping of the plurality of candidate items and the derivation of the negative example missing probability, as in the above-described embodiment.

The correction unit 23 derives a larger weight as the negative example missing probability increases, by using Equation (3). In addition, the correction unit 23 inputs the information of the user and the information of the context to the prediction model 2 to output the predicted value of the item to be recommended to the user, and derives a list of the items arranged in descending order of the predicted value. The rank of the item in the list is an example of an output result of the prediction model 2. More specifically, the rank is an example of a rank corresponding to the predicted value of the item to be recommended to the user in the present disclosure. Then, the correction unit 23 corrects the rank of the item in the list by using the weight.

FIG. 10 is a diagram for describing the correction of the rank. As a premise, there are eight items 6A to 6H, and the ranks in a list 30 are in descending order of the predicted values of the items 6A to 6H output by the prediction model 2. In addition, it is assumed that the items 6D and 6F are grouped into a group G21, the item 6A and the item 6H are grouped into a group G22, the item 6G is grouped into a group G23, and the items 6B, 6C, and 6E are grouped into a group G24. It is assumed that the group G21 has no missing negative example, and the negative example missing probabilities of the groups G22 to G24 are 0.1, 0.3, and 0.5, respectively. In this case, the weights W of the groups G22 to G24 are derived as 1.1, 1.4, and 2.0, respectively, by using Equation (3). It should be noted that, for the group G21 having no missing negative example, the negative example missing probability is indicated as 0, and the weight W is derived as 1 from Equation (3). In addition, the items 6C and 6E of the group G24 are the missing negative examples for the user, and are not output as the predicted values for the user from the prediction model 2. Therefore, in FIG. 10, the items 6C and 6E are indicated by a broken line.

The correction unit 23 corrects the ranks of the items 6A, 6B, 6D, and 6F to 6H by accumulating the weights W. Since the item 6A having the rank of first place has the weight of 1.1, the corrected rank is 1.1. Since the item 6B having the rank of second place has a high negative example missing probability and the weight of 2.0, the corrected rank is 3.1 obtained by adding 2.0 to 1.1, and is lower than the rank output by the prediction model 2. Hereinafter, similarly, the corrected rank of the item 6D having the rank of fourth place is 4.1, and the corrected ranks of the items 6F to 6H are 5.1, 6.5, and 7.6.

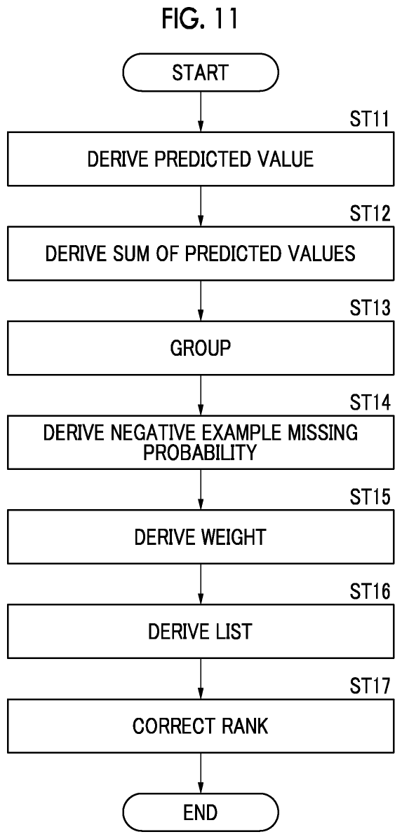

Next, processing performed in another embodiment will be described. FIG. 11 is a flowchart showing the processing performed in another embodiment. In FIG. 11, since the processing of step ST11 to step ST15 is the same as the processing of step ST1 to step ST5 in the flowchart shown in FIG. 8 in the above-described embodiment, the detailed description thereof will be omitted here.

Following step ST15, the correction unit 23 derives the list of items (step ST16). Then, the correction unit 23 corrects the rank of the item in the list by the weight (step ST17), and the processing ends.

As described above, in another embodiment, the rank corresponding to the predicted value of the item to be recommended to the user among the plurality of candidate items is derived by the prediction model 2, and the rank is corrected by the weight corresponding to the missing probability. Therefore, in a case where the missing probability of the negative example is not considered, even in a case where the predicted value of the prediction model 2 is high and the item has a high rank to be recommended to the user, it is possible to obtain the prediction result in which the apparent rank is lowered by considering the missing probability of the negative example. Therefore, the accuracy of the prediction model 2 can be evaluated by considering the missing probability of the negative example.

In the above-described embodiment, the plurality of items are grouped by using the prediction model 2, but the present disclosure is not limited thereto. The grouping may be performed by using the feature amount of the item. For example, in a case where the information processing apparatus 10 according to the present embodiment is used in an EC site, the candidate items may be grouped for each product category or for each price range by using the product category, the price range, and the like as the feature amount. In addition, for the candidate items on the review site, the candidate items may be grouped for each product category, each release date, or each price range by using the product category, the release date, the price range, and the like as the feature amount. In addition, in the medical site, the candidate items are medical data, but the candidate items may be grouped for each storage location, each modality, or each examination date by using the storage location of the medical data, the modality that acquires the image, the examination date, and the like as the feature amount.

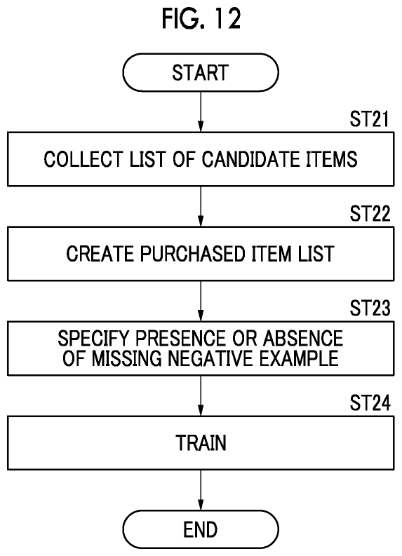

In addition, in each of the above-described embodiments, the plurality of candidate items are grouped to derive the missing probability of the negative example, but the present disclosure is not limited thereto. The negative example missing probability for each candidate item may be derived without grouping the plurality of candidate items. In this case, an estimation model for estimating the negative example missing probability is used. The estimation model is constructed by performing machine learning such that the negative example missing probability is output in a case where the feature of the item is input. Hereinafter, the machine learning of the estimation model will be described. FIG. 12 is a flowchart of processing of the machine learning of the estimation model.

In the machine learning of the estimation model, first, a list of all the candidate items at a specific date and time is collected (step ST21). In a case of the EC site, all the items at a point in time when the stocktaking of the product is performed are known. In a review site for a movie among the review sites, all the items at a certain point in time are known with reference to a database or the like in which public movies are collected. In a case of the review site for the restaurant, all the items are known by checking whether or not the restaurant is operating in a certain area on a certain day. In a case of the medical site, in a case where a list of the medical data stored in each system that handles the medical data is acquired, all the items at that point in time are known. In addition, in a case where only the examination date before a certain point in time is filtered with reference to the examination date, all the items at the certain point in time are also known.

Subsequently, a purchased item list, which is a list of all the items for which one or more users have made a purchase (review or viewing) at the specific date and time, is created (step ST22). The presence or absence of the missing negative example among all the items is specified by the list of candidate items and the purchased item list (step ST23). In this case, the missing negative example is an item for which no user has made a purchase.

Then, the estimation model is trained by using the presence or absence of the missing as a response variable and the feature of the item as an explanatory variable (step ST24). For example, in a case of the EC site, the logistic regression model is trained by Equation (4) using the product category, the price range, and the like as the explanatory variables.

y=σ(b+w_c1*xc1+w_c2*xc2+w_c3*x_c3+ . . . +w_HP*x_HP+w_MP*x_MP+w_LP*x_LP) (4)

In Equation (4), σ is a sigmoid function, x_c1, x_c2, . . . are dummy variables of 1/0 indicating whether or not the item is in the product category c1, x_HP, x_MP, and x_LP are dummy variables of 1/0 indicating whether or not the item is in the high price range, the medium price range, and the low price range, respectively, b is an offset term, and w_c1, w_c2, . . . are weights for the respective explanatory variables, which are obtained by machine learning.

In a case where the candidate item is input to the estimation model constructed by such machine learning, the negative example missing probability can be estimated. Then, the weight W can be derived by using Equation (3) and used for training the prediction model 2 and correcting the prediction result of the prediction model 2 by using the estimated negative example missing probability.

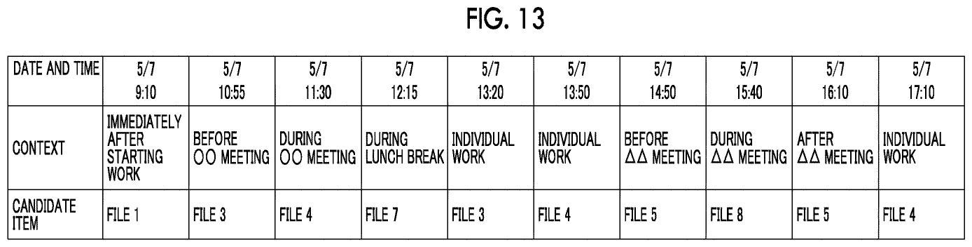

In addition, in each of the above-described embodiments, the predicted value of the candidate item for each of the plurality of users is derived by using the prediction model, but the present disclosure is not limited thereto. The predicted value of the candidate item at a plurality of points in time for a single user may be derived. For example, a plurality of files or applications in a range owned by a certain user or a range in which the user has an access right may be used as the candidate items, and a file or an application may be recommended to the user from the plurality of files or applications. Here, FIG. 13 shows a history of file viewing of the user on a certain day in a case where the candidate item is a file. In FIG. 13, eight files are used as the candidate items.

In the history of file viewing shown in FIG. 13, file 1, file 3, file 4, file 5, file 7, and file 8 are used on May 7. Since file 1 is used at 9:10 on May 7, the negative example at 9:10 on May 7 is file 3, file 4, file 5, file 7, and file 8 other than file 1 among the files used on May 7. Since file 3 is used at 10:55 on May 7, the negative example at 10:55 on May 7 is file 1, file 4, file 5, file 7, and file 8 other than file 3 among the files used on May 7. Hereinafter, the negative example at each point in time on May 7 is a file other than the file used at the point in time among the files used on May 7. Therefore, file 2 and file 6 that are not used on May 7 are negative example missing.

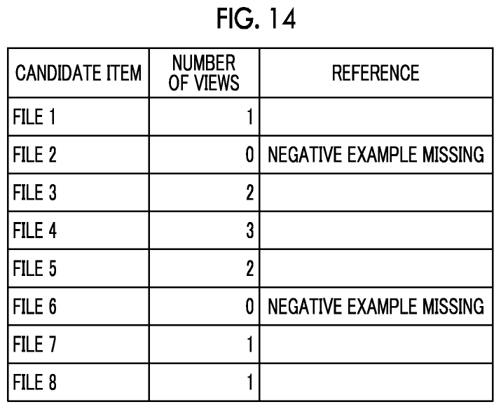

FIG. 14 shows the number of views for each candidate item in the history shown in FIG. 13. The number of views of file 1 is 1, the number of views of file 2 that is the negative example missing is 0, the number of views of file 3 is 2, the number of views of file 4 is 3, the number of views of file 5 is 2, the number of views of file 6 that is the negative example missing is 0, the number of views of file 7 is 1, and the number of views of file 8 is 1.

In this case, the derivation unit 21 derives the predicted value of the candidate item at each point in time for the single user by using the prediction model 2 stored in the storage unit 13. The predicted value is a probability that the single user for the candidate item is likely to view the candidate item at each point in time. In a case where the item is a product, the purchase rate, which is a probability that each user is likely to purchase the product, is the predicted value. Even in a case where the user is the same, the predicted value may be different due to a difference in the situation in which the user is placed at different points in time. The derivation unit 21 derives the sum of the predicted values at each point in time for the single user for each of the plurality of candidate items. Then, the derivation unit 21 groups the plurality of candidate items based on the magnitude of the sum. For example, the plurality of candidate items are divided into three groups by dividing the magnitude of the sum into three parts.

The derivation unit 21 derives the negative example missing probability for each group. Therefore, the derivation unit 21 derives an average value ng of the number of times the item is viewed for each group. For example, in a case where the plurality of candidate items are grouped into two groups G1 and G2, three items A11, A12, and A13 are present in the group G1, and the number of times the items A11, A12, and A13 are viewed is two, one, and two, respectively, the average value ng of the number of times the item is viewed is 5/3=1.67 times. In addition, in a case where three items A21, A22, and A23 are present in the group G2, and the number of times the items A21, A22, and A23 are viewed is six, eight, and five, respectively, the average value ng of the number of times the item is viewed is 19/3=6.33 times.

The number of views follows a Poisson distribution, but as in the above-described embodiment, the item of which the number of views is zero is not used for deriving the average value ng. Therefore, the distribution of the number of views is a zero-truncated Poisson distribution excluding a case where the value of the random variable is zero from the Poisson distribution.

The parameter λ of the Poisson distribution can be estimated by Equation (1), and in a case where the parameter λ is known, the negative example missing probability of each group can be calculated by Equation (2) from the Poisson distribution. In this case, in Equation (2), P(X=0) is a probability in a case where the number of views is zero. Here, in a case where the number of views is zero, since the item cannot be extracted as the candidate item, the negative example is missing. Therefore, P(X=0) is the negative example missing probability.

As in the above-described embodiment, the learning unit 22 updates the prediction model 2 by weighting the item that is the negative example with a larger weight as the negative example missing probability of the group to which the item is classified increases, and retraining the prediction model 2 using the weighted item.

Instead of deriving the predicted value of the candidate item at each point in time for a single user, the predicted value of the candidate item at each point in time for the user may be derived. In this case, the sum of the predicted values at each point in time for a plurality of users may be derived for each of a plurality of candidate items, and the plurality of candidate items may be grouped based on the magnitude of the sum.

In the present embodiment, each type of process is executed by any computer. In addition, any computer may execute these processes using a processor as hardware, a program as software, or a combination thereof. In that case, the processor is configured to execute various types of processes in the present embodiment in cooperation with the program, and may function as each unit or each means in the present embodiment. Further, the execution order of the processes by the processor is not limited to the order described and may be changed as appropriate. Any computer may be a general purpose computer, a special purpose computer, a workstation, or other system capable of executing each process.

The processor may be configured with one or a plurality of pieces of hardware, and the type of hardware is not limited. For example, the processor may be configured with hardware, such as a central processing unit (CPU), a micro processing unit (MPU), a programmable logic device, such as a field programmable gate array (FPGA), a dedicated circuit that is used to execute specific processing, such as an application-specific integrated circuit (ASIC), a graphic processing unit (GPU), or a neural processing unit (NPU). Additionally, the type of hardware may be a combination of different types of hardware. In a case where a plurality of hardware components are configured to execute one or a plurality of processes of a certain processor, the plurality of hardware components may be present in devices physically separate from each other or may be present within the same device. Further, in any of the embodiments, the order of each process performed by the processor is not limited to the order described above, and may be changed as appropriate. The hardware is configured by an electrical circuit (circuitry) in which circuit elements such as semiconductor elements are combined.

Further, the program may be software, such as firmware or a microcode. In addition, the program may be, for example, a program module group, and each function thereof may be implemented by a processor configured to execute each function. The program may be a program code or a plurality of code segments stored in one or a plurality of non-transitory computer-readable media (for example, storage media, other storages, or the like). The program may be divided and stored in the plurality of non-transitory computer-readable media present in devices physically separate from each other. The program code or code segment may represent any combination of a procedure, a function, a subprogram, a routine, a subroutine, a module, a software package, a class, or an instruction, a data structure, or a program statement. The program code or code segment may be connected to another code segment or a hardware circuit by transmitting and receiving information, data, an argument, a parameter, or a content of a memory.

Further, in the above-described embodiment, the aspect has been described in which the information processing program 12 is stored (installed) in the storage unit 13 in advance, but the present disclosure is not limited thereto. The information processing program 12 may be provided in a form recorded on a recording medium, such as a compact disc read-only memory (CD-ROM), a digital versatile disc read-only memory (DVD-ROM), and a universal serial bus (USB) memory. Alternatively, the information processing program 12 may be provided in a form that can be downloaded from an external device via a network.

The technology of the present disclosure extends to all program products. The program product includes products in any aspect for providing the program. For example, the program product includes a program provided through a network such as the Internet, a non-transitory computer-readable recording medium, such as a CD-ROM, a DVD, and a USB memory in which the program is stored, and the like.

The supplementary notes of the present disclosure will be described below.

### Supplementary Note 1

An information processing apparatus comprising:
a memory that stores a prediction model for predicting an item to be recommended to a user from a plurality of candidate items; and
a processor,
in which the processor is configured to:
   derive a missing probability of a negative example among the plurality of candidate items;
   weight the candidate item that is the negative example based on the missing probability; and
   train the prediction model by using the weighted candidate item.

### Supplementary Note 2

The information processing apparatus according to Supplementary Note 1,
in which the processor is configured to:
   group the plurality of candidate items; and
   derive the missing probability for each group.

### Supplementary Note 3

The information processing apparatus according to Supplementary Note 2,
in which the processor is configured to group the plurality of candidate items based on a feature amount of each of the plurality of candidate items.

### Supplementary Note 4

The information processing apparatus according to Supplementary Note 2,
in which the processor is configured to:
   derive a predicted value of the candidate item for each of a plurality of users by using the prediction model;
   derive a sum of the predicted values for the user for each of the plurality of candidate items; and
   group the plurality of candidate items based on a magnitude of the sum.

### Supplementary Note 5

The information processing apparatus according to Supplementary Note 2,
in which the processor is configured to:
   derive a predicted value of the candidate item at a plurality of points in time for a single user or each of a plurality of users by using the prediction model;
   derive a sum of the predicted values for the user for each of the plurality of candidate items; and
   group the plurality of candidate items based on a magnitude of the sum.

### Supplementary Note 6

The information processing apparatus according to Supplementary Note 4 or 5,
in which the processor is configured to:
   weight the candidate item that is the negative example based on the missing probability derived for each group;
   update the prediction model by using the weighted candidate item; and
   repeat the derivation of the predicted value, the derivation of the sum of the predicted values, the grouping, the weighting of the candidate item, and the update of the prediction model by using the updated prediction model until a predetermined condition is satisfied.

### Supplementary Note 7

The information processing apparatus according to any one of Supplementary Notes to 6,
in which the processor is configured to increase the weight as the missing probability increases.

### Supplementary Note 8

The information processing apparatus according to Supplementary Note 6 or 7,
in which the processor is configured to increase the number of candidate items that are the negative examples as the missing probability increases.

### Supplementary Note 9

An information processing apparatus comprising:
a memory that stores a prediction model for predicting an item to be recommended to a user from a plurality of candidate items; and
a processor,
in which the processor is configured to:
   derive a missing probability of a negative example among the plurality of candidate items; and
   correct a prediction result of the prediction model based on the missing probability.

### Supplementary Note 10

The information processing apparatus according to Supplementary Note 9,
in which the processor is configured to:
   derive a rank corresponding to a predicted value of the item to be recommended to the user among the plurality of candidate items by using the prediction model; and
   correct the prediction result of the prediction model by correcting the rank with a weight corresponding to the missing probability.

### Supplementary Note 11

An information processing method for predicting an item to be recommended to a user from a plurality of candidate items, the method comprising:
via a computer,
deriving a missing probability of a negative example among the plurality of candidate items;
weighting the candidate item that is the negative example based on the missing probability; and
training a prediction model for predicting the item by using the weighted candidate item.

### Supplementary Note 12

An information processing method for predicting an item to be recommended to a user from a plurality of candidate items, the method comprising:
via a computer,
deriving a missing probability of a negative example among the plurality of candidate items; and
correcting a prediction result of a prediction model for predicting the item based on the missing probability.

### Supplementary Note 13

An information processing program causing a computer to execute a process of predicting an item to be recommended to a user from a plurality of candidate items, the process comprising:
a procedure of deriving a missing probability of a negative example among the plurality of candidate items;
a procedure of weighting the candidate item that is the negative example based on the missing probability; and
a procedure of training a prediction model for predicting the item by using the weighted candidate item.

### Supplementary Note 14

An information processing program causing a computer to execute a process of predicting an item to be recommended to a user from a plurality of candidate items, the process comprising:
a procedure of deriving a missing probability of a negative example among the plurality of candidate items; and
a procedure of correcting a prediction result of a prediction model for predicting the item based on the missing probability.

What is claimed is:

1. An information processing apparatus comprising:
a memory that stores a prediction model for predicting an item to be recommended to a user from a plurality of candidate items; and
a processor,
wherein the processor is configured to:
derive a missing probability of a negative example among the plurality of candidate items;
weight the candidate item that is the negative example based on the missing probability; and
train the prediction model by using the weighted candidate item.

2. The information processing apparatus according to claim 1, wherein the processor is configured to:
group the plurality of candidate items; and
derive the missing probability for each group.

3. The information processing apparatus according to claim 2,
wherein the processor is configured to group the plurality of candidate items based on a feature amount of each of the plurality of candidate items.

4. The information processing apparatus according to claim 2,
wherein the processor is configured to:
derive a predicted value of the candidate item for each of a plurality of users by using the prediction model;
derive a sum of the predicted values for the user for each of the plurality of candidate items; and
group the plurality of candidate items based on a magnitude of the sum.

5. The information processing apparatus according to claim 2,
wherein the processor is configured to:
derive a predicted value of the candidate item at a plurality of points in time for a single user or each of a plurality of users by using the prediction model;
derive a sum of the predicted values for the user for each of the plurality of candidate items; and
group the plurality of candidate items based on a magnitude of the sum.

6. The information processing apparatus according to claim 4,
wherein the processor is configured to:
weight the candidate item that is the negative example based on the missing probability derived for each group;
update the prediction model by using the weighted candidate item; and
repeat the derivation of the predicted value, the derivation of the sum of the predicted values, the grouping, the weighting of the candidate item, and the update of the prediction model by using the updated prediction model until a predetermined condition is satisfied.

7. The information processing apparatus according to claim 1,
wherein the processor is configured to increase the weight as the missing probability increases.

8. The information processing apparatus according to claim 6,
wherein the processor is configured to increase the number of candidate items that are the negative examples as the missing probability increases.

9. An information processing apparatus comprising:
a memory that stores a prediction model for predicting an item to be recommended to a user from a plurality of candidate items; and
a processor,
wherein the processor is configured to:
derive a missing probability of a negative example among the plurality of candidate items; and
correct a prediction result of the prediction model based on the missing probability.

10. The information processing apparatus according to claim 9,
wherein the processor is configured to:
derive a rank corresponding to a predicted value of the item to be recommended to the user among the plurality of candidate items by using the prediction model; and
correct the prediction result of the prediction model by correcting the rank with a weight corresponding to the missing probability.

11. An information processing method for predicting an item to be recommended to a user from a plurality of candidate items, the method comprising:
via a computer,
deriving a missing probability of a negative example among the plurality of candidate items;
weighting the candidate item that is the negative example based on the missing probability; and
training a prediction model for predicting the item by using the weighted candidate item.

12. An information processing method for predicting an item to be recommended to a user from a plurality of candidate items, the method comprising:
via a computer,
deriving a missing probability of a negative example among the plurality of candidate items; and
correcting a prediction result of a prediction model for predicting the item based on the missing probability.

13. A non-transitory computer-readable storage medium that stores an information processing program causing a computer to execute a process of predicting an item to be recommended to a user from a plurality of candidate items, the process comprising:
a procedure of deriving a missing probability of a negative example among the plurality of candidate items;
a procedure of weighting the candidate item that is the negative example based on the missing probability; and
a procedure of training a prediction model for predicting the item by using the weighted candidate item.

14. A non-transitory computer-readable storage medium that stores an information processing program causing a computer to execute a process of predicting an item to be recommended to a user from a plurality of candidate items, the process comprising:
a procedure of deriving a missing probability of a negative example among the plurality of candidate items; and
a procedure of correcting a prediction result of a prediction model for predicting the item based on the missing probability.
